(19) United States
(12) Patent Application Publication
(10) Pub. No.: US 2013/0216464 A1
(43) Pub. Date: Aug. 22, 2013

(54) CATALYTIC SYSTEMS FOR CONTINUOUS CONVERSION OF SILICON TETRACHLORIDE TO TRICHLOROSILANE

(71) Applicants: Guido Stochniol, Haltern am See (DE); Thomas Müller, Hainburg (DE); Ingo Pauli, Schmitten (DE)

(72) Inventors: Guido Stochniol, Haltern am See (DE); Thomas Müller, Hainburg (DE); Ingo Pauli, Schmitten (DE)

(73) Assignee: Evonik Degussa GmbH, Essen (DE)

(21) Appl. No.: 13/522,514

(22) PCT Filed: Dec. 16, 2010
(86) PCT No.: PCT/EP2010/069920

§ 371 Date: Sep. 26, 2012

(30) Foreign Application Priority Data
Jan. 18, 2010 (DE) 102010000980.6

(51) Int. Cl. B01J 8/06; C01B 33/107

(52) U.S. Cl. CPC B01J 8/06; C01B 33/1071
USPC 423/342; 422/240; 422/129

(57) ABSTRACT

The invention relates to an improved method for converting silicon tetrachloride having hydrogen in a hydrodechlorination reactor comprising a catalyst. The invention further relates to a catalytic system for such a hydrodechlorination reactor.

The invention relates to an improved process for reacting silicon tetrachloride with hydrogen in a hydrodechlorination reactor comprising a catalyst. The invention further relates to a catalytic system for such a hydrodechlorination reactor.

In many industrial processes in silicon chemistry, SiCl₄ and HSiCl₃ form together. It is therefore necessary to interconvert these two products and hence to satisfy the particular demand for one of the products. Furthermore, high-purity HSiCl₃ is an important feedstock in the production of solar silicon.

In the hydrodechlorination of silicon tetrachloride (STC) to trichlorosilane (TCS), the industrial standard is the use of a thermally controlled process in which the STC is passed together with hydrogen into a graphite-lined reactor, known as the “Siemens furnace”. The graphite rods present in the reactor are operated in the form of resistance heating, such that temperatures of 1100° C. and higher are attained. By virtue of the high temperature and the hydrogen component, the equilibrium position is shifted toward the TCS product. The product mixture is conducted out of the reactor after the reaction and removed in complex processes. The flow through the reactor is continuous, and the inner surfaces of the reactor must consist of graphite, being a corrosion-resistant material. For stabilization, an outer metal shell is used. The outer wall of the reactor has to be cooled in order to very substantially suppress the decomposition reactions which occur at the high temperatures at the hot reactor wall, and which can lead to silicon deposits.

In addition to the disadvantageous decomposition owing to the necessary and uneconomic very high temperature, the regular cleaning of the reactor is also disadvantageous. Owing to the restricted reactor size, a series of independent reactors has to be operated, which is economically likewise disadvantageous. A further disadvantage is the performance of a purely thermal reaction without a catalyst, which makes the process very inefficient overall.

Furthermore, the present technology does not allow operation under pressure in order to achieve a higher space-time yield, in order thus, for example, to reduce the number of reactors.

EP 0 658 359 describes a process for catalytic hydrodehalogenation of halogenated compounds, in which transition metal silicides are obtained by reacting the salts of the metals with silicon and hydrogen and a halogenated silicon compound or reacting and forming fine metal powder with a halogenated silicon compound with hydrogen. The example describes an unsupported catalyst, which results in a high material consumption without full exploitation of the catalytic component. No statement is made regarding the coating of the reactor itself.

DE 41 08 614 claims a microporous material for the catalyst claimed, preferably consisting of SiO₂/Al₂O₃, for example of corresponding zeolites. A disadvantage of such systems is the poor thermal conductivity in the endothermic process described. No statement is made regarding coatings of the reactor.

EP 0 255 877 describes a supported catalyst in which the support preferably undergoes a surface treatment. No statement is made regarding any coating of the reactor.

In WO 2005/102928, an electrical heating wire is converted by silicization in a catalyst for the desired reaction. No statement is made regarding the catalytic coating of the reactor wall or regarding the use of supported catalysts.

It was thus an object of the present invention to provide a process for reacting silicon tetrachloride with hydrogen to give trichlorosilane, which works more efficiently and can achieve a higher conversion with comparable reactor size, i.e. increases the space-time yield of TCS. Furthermore, the process according to the invention should enable a high selectivity for TCS.

The problem has been solved by finding that a mixture of STC and hydrogen is conducted through a tubular reactor provided with a catalytic wall coating. It has also been found that the reactor can at the same time be operated under pressure. The combination of the use of a catalyst for improving the reaction kinetics and enhancing the selectivity and a pressurized reaction can ensure an economically and ecologically very efficient process regime. By suitable setting of the reaction parameters, such as arrangement of the catalyst, pressure, residence time, ratio of hydrogen to STC, it is possible to implement a process in which high space-time yields of TCS are obtained with a high selectivity.

The use of an inner wall coating which catalyses the reaction in the reactor, optionally in conjunction with pressure, constitutes a special feature of the process, since it is thus possible to obtain sufficiently high amounts of TCS even at comparatively low temperatures of significantly below 1000° C., preferably below 950° C., without having to accept significant losses as a result of thermal decomposition.

In this context, it has been found that it is possible to use particular ceramic materials for the reaction tubes of the reactor, since they are sufficiently inert and ensure any necessary pressure resistance of the reactor even at high temperatures, for example 1000° C., without the ceramic material, for example, being subject to a phase conversion which would damage the structure and hence adversely affect the mechanical durability. In this context, it is necessary to use gas-tight tubes. Gas-tightness and inertness can be achieved by means of high-temperature-resistant ceramics which are specified in detail below.

In addition to the catalytically active inner coating, the reactor tube may be filled with an inert bed as an additional measure, in order to optimize the flow dynamics. The bed may consist of the same material as the reactor material. The beds used may be random packings, such as rings, spheres, rods, or other suitable random packings. In a particular embodiment, the random packings may additionally be covered with a catalytically active coating.

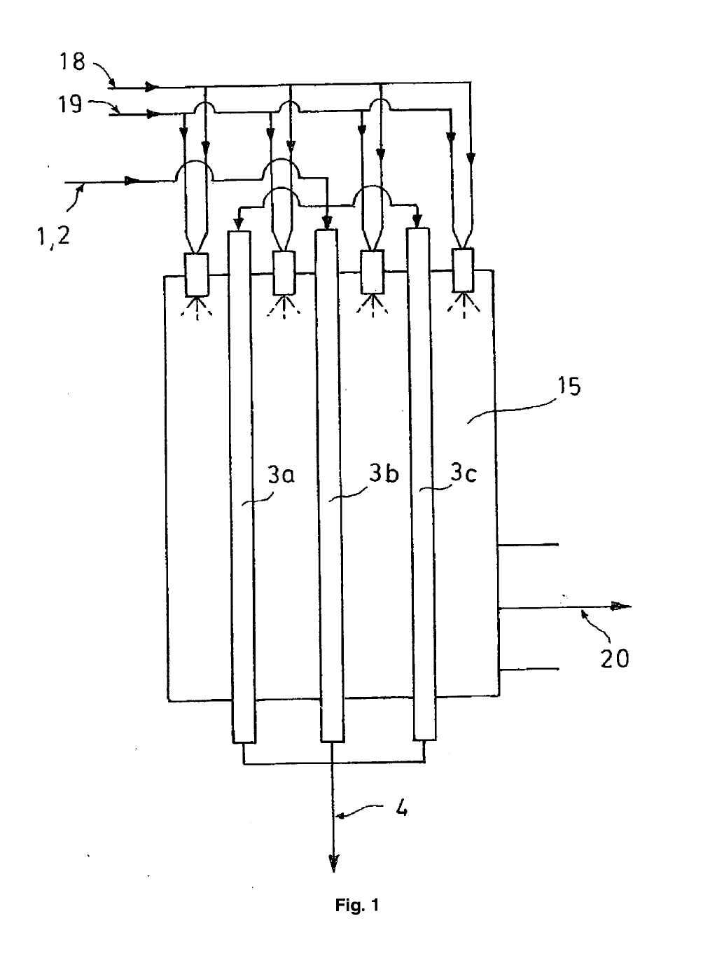

The dimensions of the reactor tube and the design of the complete reactor are determined by the availability of the tube geometry, and by the requirements regarding the introduction of the heat required for the reaction regime. It is possible to use either a single reaction tube with the corresponding periphery or a combination of many reactor tubes. In the latter case, it may be advisable to arrange many reactor tubes in a heated chamber, in which the amount of heat is introduced, for example, by means of natural gas burners. In order to avoid a local temperature peak in the reactor tubes, the burners should not be directed onto the tubes. They may, for example, be aligned into the reactor chamber indirectly from above and be distributed over the reactor chamber, as shown by way of example in FIG. 1. To enhance the energy efficiency, the reactor system may be connected to a heat recovery system.

In the production of the catalytically active coating(s) for the reactor wall and if appropriate the random packing of the reactor, a suspension, i.e. a coating material or a paste, is used, said suspension (also referred to hereinafter as coating material or paste for short) containing catalytically active metals or metal compounds and forming a solid layer with the reactor tube or the support material (the material of the fixed bed) during the heating phase. Thus, the suspension generally possesses free-flowing character at room temperature, i.e. the character of a liquid coating material, but the suspension may also be pasty. It is a particular feature of the suspension that the surface of the reactor tube or of the support need not be porous, and also does not require any pretreatment to increase the roughness. The suspension is described in detail below. The suspension is dried after application, for example by means of air or an inert gas. Subsequently, it is partly decomposed by increasing the temperature under, for example, nitrogen or hydrogen or a mixture thereof, which causes the inorganic constituents, for example the active metal, to adhere to the surface. Preference is given to establishing temperatures which are at about the level of the subsequent reaction or higher, i.e. at least 600° C., preferably 800° C., more preferably 900° C. The heat treatment can be effected after installation of the tubes and of the random packings into the reactor chamber.

The inventive achievement of the abovementioned object is described in detail hereinafter, including different or preferred embodiments.

The invention provides a process for reacting silicon tetrachloride with hydrogen to give trichlorosilane in a hydrodechlorination reactor, wherein the reaction in the hydrodechlorination reactor is catalysed by a coating which catalyses the reaction on the inner wall of the reactor.

More particularly, the process according to the invention is a process wherein the reaction is that of a silicon tetrachloride-containing reactant gas and a hydrogen-containing reactant gas in the hydrodechlorination reactor by supply of heat to form a trichlorosilane-containing and HCl-containing product gas. The product stream may possibly also comprise by-products such as dichlorosilane, monochlorosilane and/or silane. The product stream generally also comprises as yet unconverted reactants, i.e. silicon tetrachloride and hydrogen.

The equilibrium reaction in the hydrodechlorination reactor is typically performed at 700° C. to 1000° C., preferably 850° C. to 950° C., and at a pressure in the range from 1 to 10 bar, preferably from 3 to 8 bar, more preferably from 4 to 6 bar.

In all variants of the process according to the invention described, the silicon tetrachloride-containing reactant gas and the hydrogen-containing reactant gas can also be conducted into the hydrodechlorination reactor as a combined stream.

The hydrodechlorination reactor preferably comprises one or more reactor tubes which consist of ceramic material and have been provided on the inner wall with a coating which catalyses the reaction.

The ceramic material of which the one or more reactor tubes may be comprised is preferably selected from Al₂O₃, AlN, Si₃N₄, SiCN and SiC, more preferably selected from Si-infiltrated SiC, isostatically pressed SiC, hot isostatically pressed SiC or SiC sintered under ambient pressure (SSiC).

Particularly reactors with SiC-containing reactor tubes are preferred, since they possess particularly good thermal conductivity, which enable homogeneous heat distribution and good heat input for the reaction. It is especially preferred when the one or more reactor tubes consist of SiC sintered under ambient pressure (SSiC).

In a preferred embodiment of the invention, the silicon tetrachloride-containing reactant gas and/or the hydrogen-containing reactant gas is conducted into the pressurized hydrodechlorination reactor as a pressurized stream or as a pressurized combined stream, and the product gas is conducted out of the hydrodechlorination reactor as a pressurized stream.

It is envisaged in accordance with the invention that the silicon tetrachloride-containing reactant gas and/or the hydrogen-containing reactant gas is preferably conducted into the hydrodechlorination reactor with a pressure in the range from 1 to 10 bar, preferably in the range from 3 to 8 bar, more preferably in the range from 4 to 6 bar, and with a temperature in the range from 150° C. to 900° C., preferably in the range from 300° C. to 800° C., more preferably in the range from 500° C. to 700° C.

It is envisaged in accordance with the invention that the reaction in the hydrodechlorination reactor is catalysed by an inner coating which catalyses the reaction in the one or more reactor tubes. The reaction in the hydrodechlorination reactor can, however, additionally be catalysed by a coating which catalyses the reaction on a fixed bed arranged within the reactor or within the one or more reactor tubes. In this way, it is possible to maximize the catalytically useable surface area.

The catalytically active coating(s), i.e. for the inner wall of the reactor and/or any fixed bed used, consist advantageously of a composition which contains at least one active component selected from the metals Ti, Zr, Hf, Ni, Pd, Pt, Mo, W, Nb, Ta, Ba, Sr, Ca, Mg, Ru, Rh, Ir or combinations thereof, or silicide compounds thereof. Particularly preferred metals are Pt, Pd, Rh and Ir, and also mixtures or alloys thereof, especially Pt and also Pt/Pd, Pt/Rh and Pt/Ir.

The invention further provides a catalytic system for a reactor for conversion of silicon tetrachloride to trichlorosilane, said reactor comprising one or more reactor tubes, characterized in that the system comprises an inner wall coating which catalyses the conversion of silicon tetrachloride to trichlorosilane on at least one of the reactor tubes.

It is envisaged that the inventive system may additionally comprise a coating which catalyses the conversion of silicon tetrachloride to trichlorosilane on a fixed bed arranged in the at least one reactor tube.

In a preferred embodiment of the invention, the catalytic system comprises, in addition to the catalysing inner wall coating, reactor tubes composed of a ceramic material. It is preferred that the ceramic material is selected from Al₂O₃, AlN, Si₃N₄, SiCN and SiC; the ceramic material is more preferably selected from Si-infiltrated SiC, isostatically pressed SiC, hot isostatically pressed SiC or SiC sintered under ambient pressure (SSiC).

The catalytic system comprising one or more reactor tubes and an inner wall coating which catalyses the conversion of silicon tetrachloride to trichlorosilane can be prepared as follows:

by providing a suspension, i.e. a coating material or a paste, containing a) at least one active component selected from the metals Ti, Zr, Hf, Ni, Pd, Pt, Mo, W, Nb, Ta, Ba, Sr, Ca, Mg, Ru, Rh, Ir or combinations thereof or silicide compounds thereof, b) at least one suspension medium, and optionally c) at least one auxiliary component, especially for stabilizing the suspension, for improving the storage stability of the suspension, for improving the adhesion of the suspension to the surface to be coated and/or for improving the application of the suspension to the surface to be coated; by applying the suspension to the inner wall of the one or more reactor tubes and, optionally, by applying the suspension to the surface of random packings of any fixed bed provided; by drying the suspension applied; and by heat-treating the applied and dried suspension at a temperature in the range from 500° C. to 1500° C. under inert gas or hydrogen. The heat-treated random packings can then be introduced into the one or more reactor tubes. The heat treatment and optionally also the preceding drying may, however, also be effected with already introduced random packings. The suspension media used in component b) of the inventive suspension, i.e. coating material or paste, especially those suspension media with binding character (also referred to as binders for short), may advantageously be thermoplastic polymeric acrylate resins as used in the paints and coatings industry. Examples include polymethyl acrylate, polyethyl acrylate, polypropyl methacrylate or polybutyl acrylate. These are systems customary on the market, for example those obtainable under the Degalan® brand name from Evonik Industries.

Optionally, the further components used, i.e. in the sense of component c), may advantageously be one or more auxiliaries or auxiliary components.

For instance, the auxiliary component c) used may optionally be solvent or diluent. Suitable with preference are organic solvents, especially aromatic solvents or diluents, such as toluene, xylenes, and also ketones, aldehydes, esters, alcohols or mixtures of at least two of the aforementioned solvents or diluents.

A stabilization of the suspension can—if required—advantageously be achieved by inorganic or organic rheology additives. The preferred inorganic rheology additives as component c) include, for example, kieselguhr, bentonites, smectites and attapulgites, synthetic sheet silicates, fumed silica or precipitated silica. The organic rheology additives or auxiliary components c) preferably include castor oil and derivatives thereof, such as polyamide-modified castor oil, polyolefin or polyolefin-modified polyamide, and polyamide and derivatives thereof, as sold, for example, under the Luvotix® brand name, and also mixed systems composed of inorganic and organic rheology additives.

In order to achieve an advantageous adhesion, the auxiliary components c) used may also be suitable adhesion promoters from the group of the silanes or siloxanes. Examples for this purpose include—though not exclusively—dimethyl-, diethyl-, dipropyl-, dibutyl-, diphenylpolysiloxane or mixed systems thereof, for example phenylethyl- or phenylbutylsiloxanes or other mixed systems, and mixtures thereof.

The inventive coating material, i.e. the paste, may be obtained in a comparatively simple and economically viable manner, for example, by mixing, stirring or kneading the feedstocks (cf. components a), b) and optionally c)) in corresponding common apparatus known per se to those skilled in the art. In addition, reference is made to the present inventive examples.

FIG. 1 shows, illustratively and schematically, a hydrodechlorination reactor which can be used in the inventive manner for reaction of silicon tetrachloride with hydrogen to give trichlorosilane, provided that it has been equipped with an appropriate catalytically active coating (not shown).

The hydrodechlorination reactor shown in FIG. 1 comprises a plurality of reactor tubes 3a, 3b, 3c arranged in a combustion chamber 15, a combined reactant gas 1, 2 which is conducted into the plurality of reactor tubes 3a, 3b, 3c, and a line 4 (for a product stream) conducted out of the plurality of reactor tubes 3a, 3b, 3c. The reactor shown also includes a combustion chamber 15 and a line for combustion gas 18 and a line for combustion air 19, which lead to the four burners shown in the combustion chamber 15. Also shown, finally, is a line for flue gas 20 which leads out of the combustion chamber 15. The catalysing coating provided in accordance with the invention on the inner wall of the reactor tubes 3a, 3b, 3c, and also a fixed bed optionally arranged in the reactor tubes 3a, 3b, 3c, are not shown.

### EXAMPLES

### Example 1

A paste containing the catalyst, in the form of a liquid coating material, was prepared by mixing the following components together:

7 g of platinum black, 10 g of aluminium powder (d₅₀ about 11 μm), 3.5 g of phenylethylpolysiloxane (oligomer), 0.3 g of fumed silica (Aerosil® 300, Evonik Degussa GmbH), 10 g of poly(methyl/butyl methacrylate) as a 40% mixture in toluene, 40 ml of toluene.

A sufficient amount of this coating material was introduced into an SSiC reaction tube with the dimensions of length=1100 mm, internal diameter=5 mm that approx. 1 g of dried catalyst paste was present homogeneously on the inner surface of the tube.

### Example 2

The formulation was prepared as in Example 1, except that the same amount of tungsten silicide (Sigma-Aldrich) was used in place of the platinum black.

### Example 3

The SSiC tube was used without the use of a catalytically active paste.

### Example 4

The formulation was produced as in Example 1, except that the same amount of nickel powder was used in place of the platinum black.

### Example 5

General test procedure, applies to Examples 1 to 4: The reactor tube was placed into an electrically heatable tube furnace. First, the tube furnace containing the particular tube was brought to 900° C., in the course of which nitrogen at 3 bar absolute was passed through the reaction tube. After two hours, the nitrogen was replaced by hydrogen. After a further hour in the hydrogen stream, likewise at 3 bar absolute, 36.3 ml/h of silicon tetrachloride were pumped into the reaction tube. The hydrogen stream was adjusted to a molar excess of 4.2 to 1. The reactor discharge was analysed by online gas chromatography, and this was used to calculate the silicon tetrachloride conversion and the molar selectivity to give trichlorosilane.

The results are shown in Table 1.

The only secondary component found in Examples 2 to 4 was dichlorosilane. The hydrogen chloride formed was not excluded from the calculation and not assessed.

TABLE 1
Results of the catalytic reaction of STC with hydrogen

| | | | TCS | DCS |
|---|---|---|---|---|
| | | | selectivity | selectivity |
| | Metal component | ST conversion [%] | [%] | [%] |
| Ex. 1 | Platinum | 23.6 | >99.9 | — |
| Ex. 2 | Tungsten silicide | 25.6 | 98.91 | 0.09 |
| Ex. 3 | SSiC tube | 25.8 | 96.57 | 0.43 |
| Ex. 4 | Nickel | 16.2 | 99.42 | 0.58 |

STC = Silicon tetrachloride
TCS = Trichlorosilane
DCS = Dichlorosilane

### LIST OF REFERENCE NUMERALS

(1) silicon tetrachloride-containing reactant gas
(2) hydrogen-containing reactant gas
(1, 2) combined reactant gas
(3) hydrodechlorination reactor
(3a, 3b, 3c) reactor tubes
(4) product stream
(15) heating space or combustion chamber
(18) combustion gas
(19) combustion air
(20) flue gas

1. A process comprising reacting, in a hydrodechlorination reactor, silicon tetrachloride with hydrogen to obtain trichlorosilane, wherein a coating on an inner wall of the reactor catalyzes the reaction.

2. The process of claim 1, comprising reacting a silicon tetrachloride-comprising reactant gas and a hydrogen-comprising reactant gas in the hydrodechlorination reactor by supplying heat, to obtain a product gas comprising trichlorosilane and HCl.

3. The process of claim 2, wherein the silicon tetrachloride-comprising reactant gas and the hydrogen-comprising reactant gas pass into the hydrodechlorination reactor in a combined stream.

4. The process of claim 1, wherein the hydrodechlorination reactor comprises a reactor tube, the coating is disposed on an inner wall of the reactor tube, and the reactor tube comprises a ceramic material.

5. The process of claim 4, wherein the ceramic material is selected from the group consisting of Al₂O₃, AlN, Si₃N₄, SiCN and SiC.

6. The process of claim 5, wherein the ceramic material is selected from the group consisting of Si-infiltrated SiC, isostatically pressed SiC, hot isostatically pressed SiC, and SiC sintered under ambient pressure (SSiC).

7. The process of claim 4, wherein the reactor tube comprises SiC sintered under ambient pressure (SSiC).

8. The process of claim 2, wherein (i) the silicon tetrachloride-comprising reactant gas, (ii) hydrogen-comprising reactant gas, or both (i) and (ii) pass into the hydrodechlorination reactor as pressurized streams or as a pressurized combined stream, the reactor is pressurized, and the product gas passes out of the hydrodechlorination reactor as a pressurized stream.

9. The process of claim 8, wherein (i) the silicon tetrachloride-comprising reactant gas, (ii) the hydrogen-comprising reactant gas, both (i) and (ii), or the pressurized combined stream pass into the hydrodechlorination reactor with a pressure of 1 to 10 bar, and with a temperature of 150° C. to 900° C.

10. The process of claim 1, wherein the reactor further comprises a fixed bed, and the coating is further disposed on the fixed bed.

11. The process of claim 1, wherein the coating comprises at least one catalytically active metal component selected from the group consisting of Ti, Zr, Hf, Ni, Pd, Pt, Mo, W, Nb, Ta, Ba, Sr, Ca, Mg, Ru, Rh, Ir, and silicide compounds thereof.

12. A catalytic system comprising a reactor comprising a reactor tube, wherein a coating on an inner wall of the reactor tube catalyzes a conversion of silicon tetrachloride to trichlorosilane.

13. The catalytic system of claim 12, wherein the reactor further comprises a fixed bed disposed in the reactor tube, and the coating is further disposed on the fixed bed.

14. The catalytic system of claim 12, wherein the reactor tube comprises a ceramic material.

15. The catalytic system of claim 14, wherein the ceramic material is selected from the group consisting of Al₂O₃, AlN, Si₃N₄, SiCN and SiC.

16. The catalytic system of claim 15, wherein the ceramic material is selected from the group consisting of Si-infiltrated SiC, isostatically pressed SiC, hot isostatically pressed SiC, and SiC sintered under ambient pressure (SSiC).

17. The catalytic system of claim 12, wherein the system is prepared by a process comprising:
applying to the inner wall of the reactor tube a suspension comprising a) at least one active metal component selected from the group consisting of Ti, Zr, Hf, Ni, Pd, Pt, Mo, W, Nb, Ta, Ba, Sr, Ca, Mg, Ru, Rh, Ir, and silicide compounds thereof, b) a suspension medium, and optionally c) an auxiliary component that stabilizes the suspension, that improves a storage stability of the suspension, that improves an adhesion of the suspension to a surface to be coated and/or that improves an application of the suspension to the surface to be coated;
optionally applying the suspension to a surface of random packings of a fixed bed;
drying the applied suspension;
heat-treating the applied and dried suspension at a temperature of 500° C. to 1500° C. in the presence of an inert gas or hydrogen; and
optionally introducing the heat-treated random packings into the reactor tube.

18. The process of claim 4, wherein the reactor further comprises a fixed bed disposed in the reactor tube, and the coating is further disposed on the fixed bed.

19. The process of claim 1, wherein the coating comprises at least one catalytically active metal component selected from the group consisting of Pt, Pd, Rh and Ir.

20. The process of claim 8, wherein (i) the silicon-tetrachloride-comprising reactant gas, (ii) the hydrogen-comprising reactant gas, both (i) and (ii), or the pressurized combined stream pass into the hydrodechlorination reactor with a pressure of 4 to 6 bar, and with a temperature of 500° C. to 700° C.
